(19) United States
(12) Patent Application Publication
(10) Pub. No.: US 2017/0240251 A1
(43) Pub. Date: Aug. 24, 2017

(54) LIQUEFIED NATURAL GAS FUEL BARGE

(71) Applicants: James H. Wait, JR., Dover, MA (US); Trinity Marine Products, Inc., Dallas, TX (US)

(72) Inventors: James H. Wait, JR., Dover, MA (US); Neal E. Langdon, Goodlettsville, TN (US)

(21) Appl. No.: 15/436,361

(22) Filed: Feb. 17, 2017

Related U.S. Application Data
(60) Provisional application No. 62/296,739, filed on Feb. 18, 2016.

(51) Int. Cl. B63B 27/25; F17C 11/00; B63B 27/34; B63B 35/28; B63B 25/12

(52) U.S. Cl. CPC B63B 27/25; B63B 35/28; B63B 25/12; B63B 27/34; F17C 11/007; F17C 2270/0113

(57) ABSTRACT

A system that includes a marine vessel with a vaporizer skid disposed on the marine vessel. The vaporizer skid is configured to convert a liquid to a gas. The system further includes a first tank disposed on the marine vessel that is configured to store the liquid. The system further includes a plurality of header modules disposed on the marine vessel. The plurality of header modules form a piping network that provide a first flow path from the first tank to the vaporizer skid and a second flow path from the vaporizer skid to a connective interface. The connective interface is configured to provide a flow path from at least one of the plurality of header modules to an end-user system.

### CROSS-REFERENCE TO RELATED APPLICATIONS

The present application claims benefit of U.S. Provisional Patent Application No. 62/296,739 filed Feb. 18, 2016 by James H. Wait, et al., and entitled “Liquefied Natural Gas Fuel Barge,” which is incorporated herein by reference as if reproduced in their entirety.

### TECHNICAL FIELD

This disclosure relates generally to providing a means for storing, transporting, and distributing bulk liquid commodities, such as Liquefied Natural Gas (LNG), as a fuel for marine vessels or various commercial and industrial applications.

### BACKGROUND

Liquid fuel commodities such as LNG may be stored on a marine vessel and used as a fuel source for the marine vessels or for auxiliary equipment (e.g. cargo heaters and power generation) on the marine vessel. LNG is widely viewed as an attractive alternative to traditional distillate fuels (e.g. diesel) primarily due to its ability to reduce SOx, NOx, CO2, and particulate matter emissions to levels significantly below those mandated by the International Maritime Organization (IMO). Increasing the number of marine vessels employing LNG fuel globally within marine markets and/or the adoption rate of new builds or retrofits is challenging. Capital investment, return on that capital investment, design aspects of retrofitting, and LNG fueling infrastructure remain amongst the most significant aspects challenging gaseous fuels implementations, especially in inland navigation.

Retrofitting existing vessels or designing new build vessels to accommodate tanks for liquid gas fuels is challenging due to space limitations and the stringent regulatory requirements on marine vessels contemplating burning gaseous fuels. One problem with retrofitting inland push boats is finding space for the LNG fuel tanks which occupy 2.5 to 4 times greater space than conventional tanks (e.g. diesel tanks). For stability reasons, push boat fuel tanks are typically located at or near the center of mass of the vessel where the engine room is already located. In addition, fuel tanks are one of the most costly components of an LNG retrofit. This cost stresses a ship owner's return on investment calculations.

### SUMMARY

In one embodiment, the disclosure includes a system that includes a marine vessel with a vaporizer skid disposed on the marine vessel. One or more intermodal tanks are utilized to store LNG fuel on board the marine vessel. Stored LNG is vaporized on board then transferred as fuel to an end user. In some embodiments, liquid LNG may also be discharged directly to an end user for use as fuel. A piping system employing a common vapor vent system and a common LNG fuel transfer system is integrated within modular header frames. Each header module is configured to accommodate one or more tanks. The one or more interconnected header modules facilitate the expanded storage capacity. Each tank is detachably coupled to the common vapor vent system and the LNG fuel transfer system housed within the header modules. Header modules establish flow paths to the vaporizer skid and the vapor relief valve. In the event of a tank over-pressurization, boil-off gas is directed to a vent riser (e.g. a relief valve) through the common vapor vent system. Each tank is capable of being rapidly detached to allow the expedient lift-on/lift-off exchange of tanks. Header modules and tanks may be secured onboard in a manner consistent with standard container vessel practice using connective devices including, but not limited to, twist-locks and bridge clamps. In one embodiment, individual tanks may be secured within cellular guide rails affixed to the header modules. The interconnected header modules are utilized to facilitate customized configurations of storage tanks and auxiliary equipment.

In one embodiment, the disclosure includes a system that includes a marine vessel with a vaporizer skid disposed on the marine vessel. The vaporizer skid converts a liquid to a gas. The system further includes a first tank disposed on the marine vessel that stores the liquid. The system further includes a plurality of header modules disposed on the marine vessel that form a piping network. The header modules provide a first flow path from the first tank to the vaporizer skid and a second flow path from the vaporizer skid to a connective interface. The system further includes the connective interface that provides a flow path from at least one of the header modules to an end-user system. Examples of end-user systems include, but are not limited to, a second marine vessel, on-board and onshore a power generation systems, and on-board and onshore desalinization systems.

In another embodiment, the disclosure includes a method that includes transferring a liquid from a first tank to a vaporizer skid using a plurality of header modules. The tank, vaporizer skid, and the plurality of header modules are disposed on a first marine vessel. The method further includes converting the liquid to a vaporized gas using the vaporizer skid and transferring the vaporized gas from the vaporizer skid to an end-user system (e.g. a second marine vessel) using at least one of the plurality of header modules.

Various embodiments present several technical advantages, such as eliminating or reducing the necessity of direct investing in fuel tanks (e.g. LNG fuel tanks) by a marine vessel owner or operator employing duel fuel technology, especially inland markets. The ability to swap out empty fuel barges for full ones reduces the need for fleets to be fueled mid-stream. The fuel barge may be configured to supply LNG or vaporized LNG depending on the machinery specifications of the consumer. The fuel barge is reconfigurable to allow for different arrangements in both the number of fuel tanks and the size of the fuel tanks that may be employed. Fuel barges may also be used to provide supplemental intermodal and liquid bulk storage and transport.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a side view of an embodiment of a fuel barge configured to supply vaporized LNG fuel to a marine tow;

FIG. 2 is a cross-section view of an embodiment of a fuel barge;

FIG. 3 is a schematic view of an embodiment of header modules configured to form flow paths between the header modules;

FIG. 4 is a top view of an embodiment of a fuel barge;

FIG. 5 is a top view of another embodiment of a fuel barge;

FIG. 6 is a side view of an embodiment of a fuel barge with a power generation module; and

FIG. 7 is a flowchart of an embodiment of a fuel distribution method.

### DETAILED DESCRIPTION

Disclosed herein are various embodiments of a fuel barge configured to store, transport, and provide a fuel supply (e.g. natural gas) to another marine vessel that is operably coupled to the fuel barge. A fuel barge may also be referred to as a multi-purpose fuel barge or a tender barge. The fuel barge directly addresses some of the challenges of capital investment and return on investment through various embodiments which physically displace the LNG fuel tanks from the end-user consumer, for example, a marine vessel or an onshore system, to a fuel supplier floating asset. The fuel barge exploits the capital efficiency of mass produced barge hull forms and standard dimensions (e.g. inland ‘hopper barge’ or ‘flat deck barge’) as a floating infrastructure platform, while employing modular components which facilitate flexible functionality and the safe stowage and distribution of the fuel as vaporized natural gas. The modular components also accommodate a multitude of modular safety and auxiliary equipment as well as machinery capable of serving a variety of functions in service to multiple cross-sector inland and near-shore market applications (e.g. power generation and desalinization).

In one embodiment, when acting in a service capacity to inland and near-shore markets, the fuel barge may be built with dimensions close to standard river barge dimensions. Using dimensions close to standard river barge dimensions may be advantageous in that it allows the fuel barge to better integrate into various inland tow flotilla's and configurations. One of ordinary skill in the art would appreciate that the fuel barge dimensions, stowage, and fuel output capacity can be scaled up or down. The fuel barge may be configured to be towed (e.g. pushed) by a marine vessel coupled to the fuel barge. Examples of other marine vessels that may be operably coupled to or interconnected with the fuel barge include, but are not limited to, tug boats, push boats, and barges.

In one embodiment, a fuel barge may be configured to provide propulsion fuel and/or auxiliary fuel. For example, a fuel barge is configured to fuel interconnected hot oil barges fitted with gas fired auxiliary heaters and/or their attending push boat. In one embodiment, this same fuel barge may be configured to provide natural gas fuel to the attending push boat as well. As another example, a fuel barge is configured to fuel a push boat working a flotilla of inland barges. In this example, the fuel barge extends the effective travel range of the attending push boat and its flotilla.

As would be appreciated by one of ordinary skill in the art, a fuel barge may be configured to support other types of service applications. For example, the fuel barge may act as a mobile floating fuel source to various industrial, marine, and power applications. The fuel barge is generally configured to provide fuel to one or more on-board end-user systems and/or external end-user systems. Examples of external end-user systems include, but are not limited to, other marine vessels, onshore power generation systems, and onshore desalinization systems. For example, the fuel barge may be configured as a floating industrial fuel source for an onshore power generation system or an onshore desalinization facility. As another example, the fuel barge may be configured to provide supplementary peaking fuel supply to commercial, industrial, and/or utility markets. As another example, the fuel barge may be configured to provide “cold-ironing” power to merchant vessels while in port.

In one embodiment, the fuel barge is configured to fully or partially displace LNG fuel storage capacity of another marine vessel (e.g. a push boat or barge) that is operably coupled to the fuel barge. Displacing the fuel storage allows fuel tanks to be located on the fuel barge and not on the marine vessel. This simplifies the push boat retrofit configuration while providing the option for owners and operators to defer tank storage ownership to a third-party fuel service provider. The fuel barge's ability to displace fuel storage may be a driver to incentivize inland push boat and hot oil barge operators to convert their engines and/or auxiliary equipment to natural gas.

Fuel barges are exchangeable and removably coupled to marine vessels which allows a marine vessel to swap an empty fuel barge for a full fuel barge (e.g. drop and swap). This bunkering procedure would eliminate the need for traditional mid-stream bunkering. For example, marine vessels may use a first fuel barge as a fuel source and replace the first fuel barge with another fuel barge when the first fuel barge is depleted of fuel. Empty fuel barge International Organization for Standardization (ISO) containers may be exchanged for full ISO containers at a container terminal or may be filled at an approved bunkering facility. The ability to exchange containers eliminates the need for building and servicing with costly midstream assets (e.g. LNG bunker vessels) and may reduce the regulatory burden from a design and operations perspective.

In one embodiment, the fuel barge is configured to transfer low pressure natural gas such as to a hot oil barge for fueling their auxiliary heater. Transference of low pressure natural gas as opposed to higher pressure LNG significantly enhances the safety profile of the transfer from an operational risk perspective. This approach is unlike the traditional bunkering of a hot oil barge and her attending tug which would involve the midstream direct transfer of cryogenic LNG fuel while underway. In another embodiment, the fuel barge may be configured to directly transfer LNG liquid gas fuels in accordance with the machinery specifications of the end consumer requirements.

In one embodiment, the fuel barge is configured to employ interconnected LNG ISO storage tanks to flow positively regulated LNG through a vaporization system which provides regulated natural gas distribution. The vaporization system distributes vaporized LNG to various end consumer systems through a suitable piping and interface system.

In one embodiment, the fuel barge may be configured to support unmanned applications. Safety, positive control, and/or monitoring may be provided by a control skid central processing unit (CPU) with a telemetric remote user interface and visual displays. The fuel barge may be configured to provide gas and heat detection and to employ automatic valves that may be triggered in response to gas or heat detections. The fuel barge may also be configured to provide real-time data such as notifications, pressures, temperatures, tank levels, and alarms. The fuel barge may provide enhanced visual and telemetry attendance, for example, via redundant mobile or satellite phone. The safety features and remote monitoring capabilities of the fuel barge allow the fuel barge to be operated without requiring additional crew personnel to operate the fuel barge.

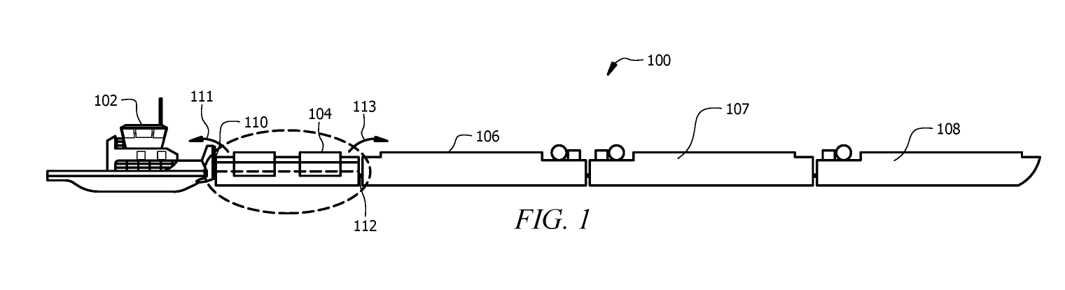

FIG. 1 is a side view of an embodiment of a fuel barge 104 configured to supply vaporized LNG fuel to a marine tow 100. The marine tow 100 comprises a push boat 102 operably coupled to the fuel barge 104. The fuel barge 104 is also operably coupled to a first barge 106 of a series of interconnected barges 106, 107, and 108. For example, the marine tow 100 may be configured as a series of inland “hot oil barges” that are each fitted with natural gas fired auxiliary heaters and an interconnected push boat 102. The push boat 102, the fuel barge 104, and barges 106-108 may be coupled together using any suitable technique as would be appreciated by one of ordinary skill in the art. The marine tow 100 may be configured as shown or in any other suitable traditional configuration. For example, the fuel barge 104 may be connected to a single marine vessel (e.g. a push boat) or may be integrated with a flotilla.

Examples of fuel barge 104 marine vessels include, but are not limited to, an inland hopper barge, a flat-deck barge, a custom barge, and/or any other suitable type of marine vessel. The fuel barge 104 is configured to store and to transport liquid commodity tanks (e.g. LNG tanks) that may be used as a fuel source for the push boat 102 and/or the barge 106. In one embodiment, the fuel barge 104 is configured to store LNG liquid in one or more LNG tanks disposed on the fuel barge 104, to vaporize the LNG liquid into vaporized LNG gas using a vaporizer skid, and to distribute the pressure regulated natural gas to the push boat 102 and/or the barges 106, 107, and 108. The fuel barge 104 is configured to transfer LNG liquids from the LNG tanks to an integrated modular vaporizer skid that converts the LNG liquids into a vaporized gas and to distribute the vaporized LNG gas to other marine vessels as a fuel source. The vaporized gas may be distributed to other marine vessels (e.g. push boat 102 or barges 106, 107, and 108), other external systems, and/or to other marine vessel equipment via connective interface 110 and 112. For example, the fuel barge 104 may be configured to provide vaporized gas to the push boat 102 using a flow path 111 provided by connective interface 110 and to provide vaporized gas to barge 106 using a flow path 113 provided by connective interface 112. In other embodiments, the fuel barge 104 is configured to store any other suitable type of liquid commodity or cargo.

Connective interface 110 and 112 may take the form of a flexible (e.g. hose) or semi-rigid hard arm (e.g. an articulated conduit system) which accounts for relative movements between the two vessels (e.g. fuel barge 104 and barge 106) while providing a positive natural gas interconnection to other marine vessels or marine vessel equipment. Connections between the connective interface 110 and 112 and other marine vessel may comprise break-away fittings, dry-break couplings, hard-arms, hoses, pipes, piping elbows, clamps, valves, or any other suitable components for making a connection as would be appreciated by one of ordinary skill in the art upon viewing this disclosure.

In one embodiment, the connective interfaces 110 and 112 at least partially couples the fuel barge 104 to other marine vessels. For example, the connective interfaces 110 and 112 may be integrated with other hardware or structures that are used to couple the fuel barge 104 to another marine vessels. Any other suitable hardware for connecting the fuel barge 104 to another marine vessels may be employed as would be appreciated by one of ordinary skill in the art.

In other embodiments, the fuel barge 104 is configured to provide fuel (e.g. vaporized LNG gas) to one or more on-board end-user systems and/or one or more external end-user systems located onshore or near-shore. For example, the fuel barge 104 may be operably coupled to and configured to provide fuel to an onshore power generation system, an onshore desalinization facility or system, and/or any other suitable system external from the fuel barge 104. The power generation system may be configured to obtain fuel from the fuel barge 104 and to provide power (e.g. electric power or mechanical power) for another system or device. For example, the power generation system is configured to use vaporized LNG gas from the fuel barge 104 as a fuel source to operate the power generation system to provide power for a dredge or for a vessel as cold-ironing power.

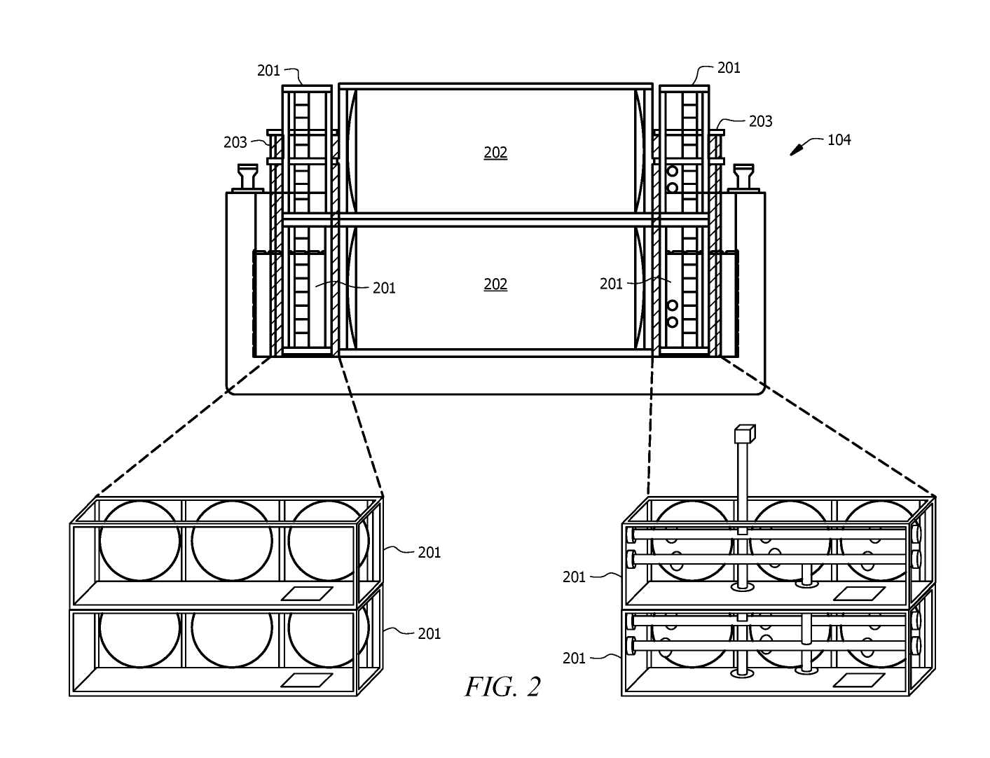

FIG. 2 is a cross-section view of an embodiment of a fuel barge 104. The fuel barge 104 is a marine vessel comprising header modules 201 and tanks 202 (e.g. LNG tanks). The fuel barge 104 uses an inter-locking modular design that allows components (e.g. header modules 201 and tanks 202) of the fuel barge 104 to be removable or exchangeable. Each header module 201 is a cellular guide module comprising piping disposed within a frame structure that is used for connecting with tanks 202, other header modules 201, and other equipment on the fuel barge 104. The header modules 201 are operably coupled to each other to form a piping network for the fuel barge 104. The header modules 201 are configured to interface with and connect various components on the fuel barge 104. The header modules 201 are also configured to provide flow paths for communicating fluids and gases between the tanks 202, other equipment on the fuel barge (e.g. a vaporizer skid), and other systems or vessels.

In one embodiment, one or more of header modules 201 are configured to at least partially secure a tank 202 to the fuel barge 104. Header modules 201 may be configured to support tanks 202 and/or to couple tanks 202 to the fuel barge 104. For example, the header module 201 may be configured to form a free-standing inter-locking framework that stabilizes and secures the tanks 202 in rows, tiers, and bays.

In one embodiment, header modules 201 are configured to secure one or more tanks 202 to the fuel barge 104 using cellular guides 203. A cellular guide 203 is a vertical structure that guides and secures containers into well-defined vertical tiers and rows. The cellular guides 203 provide support to the tanks 202 against vessel dynamic movements at sea. A cellular guide 203 may be configured to align header modules 201 and to assist in the orientating header modules when being coupled together. Cellular guides 203 may also be configured to interface with and connect to other components, for example, a ISO container structure of a tank 202. Cellular guides 203 may be configured as an integral component of header modules 201 which, in turn, provide secure stowage support to tanks 202.

Header modules 201 may form a stable interlocking framework which employs permanent (e.g. welds), semi-permanent, and/or removable connections to connect header modules 201 to other header modules 201, cellular guides 203, and/or the fuel barge 104. In one embodiment, header modules 201 may be connected to other header modules 201, cellular guides 203, and/or the fuel barge 104 using modular container lashing components including, but not limited to, foundation stacker locking devices, twist locks, dove tail twist locks, foundation twist locks, and bridge clamps. In other embodiments, header modules 201 may be connected to other header modules 201, cellular guides 203, and/or the fuel barge 104 using any other suitable type of connective methodology or components.

The tanks 202 are configured to store fuel (e.g. Liquefied Natural Gas or liquid petroleum fuel). Tanks 202 may be stacked or placed end-to-end to form rows, tiers, and bays across the fuel barge 104. For example, in FIG. 2, the tanks 202 are shown in a stacked configuration. The tanks 202 may use a free-standing design (e.g. type ‘C’), a fully integrated fixed membrane design, type ‘A’, type ‘B’, or may be formed using one or more ISO containers. For example, a tank 202 may be integrated with or formed with a 20 foot or a 40 foot ISO container. The fuel barge 104 comprises any suitable number and/or configuration of tanks 202. Two or more tanks 202 may be coupled together to form an intermodal module of tanks 202. For example, a pair of tanks 202 may be coupled together to form an intermodal module.

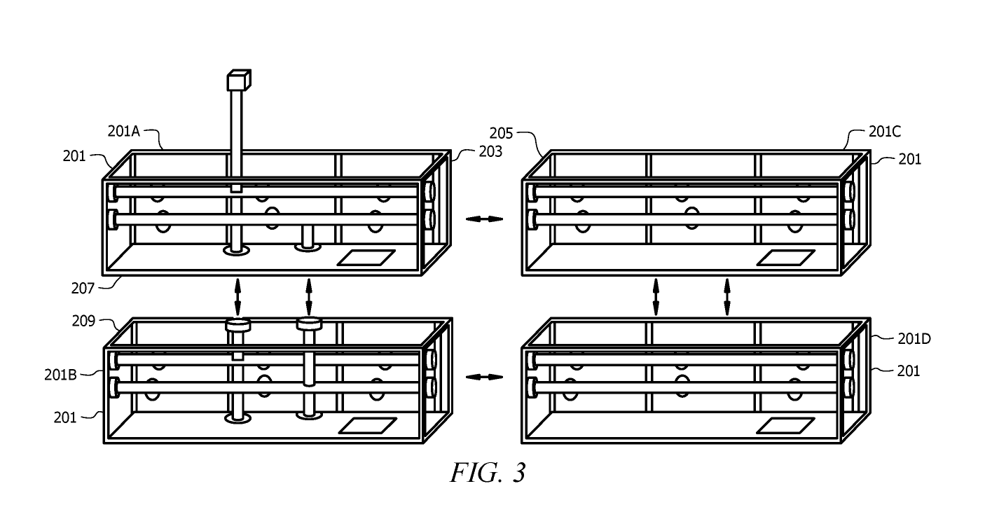

FIG. 3 is a schematic view of an embodiment of header modules 201 configured to form flow paths (e.g. LNG and vapor flow paths) between the header modules 201. Header modules 201 comprise a frame structure configured to house components that may be interconnected with components in other header modules 201 and/or other components of the fuel barge 104. Examples of components housed within a header module 201 include, but are not limited to, piping (e.g. LNG piping and vapor piping), flexible hoses, valves, pressure relief valves, vapor vent mast risers, vent stacks, electrical wires, electrical conduits, lighting components, cryo-connectors, water spray components, safety monitoring equipment, and/or any other suitable components. Component of a header module 201 may be interfaced with and connected to other components using bolted flanges, couplings, expansion joints, quick couplings, threaded couplings, and/or any other suitable type of connection.

In one embodiment, the dimensions of the frame structure for a header module 201 may be configured to span and interconnect two or more tanks 202. In one embodiment, the dimensions of the frame structure for a header module 201 may be adjustable. For example, a header module 201 frame may comprise telescoping components that allows the size of the header module 201 to be adjusted. Header modules 201 on a fuel barge 104 may be configured to all have the same dimensions or with varying dimensions.

Header modules 201 may be stacked vertically to connect two header modules 201 and to form a flow path between the two header modules 201. For example, a lower portion 207 of a first header module 201A may be stacked onto an upper portion 209 of a second header module 201B. When the first header module 201A is stacked on top of the second header module 201B, corresponding piping and/or interfaces align and mate with each other to form flow paths (e.g. a vapor or liquid flow path) between the first header module 201A and the second header modules 201B.

Header modules 201 may be connected end-to-end to connect two header modules 201 and to form a flow path between the two header modules 201. For example, an end portion 203 of the first header module 201A may be connected with an end portion 205 of a third header module 201C. When the first header module 201A is connected end-to-end with the third header module 201C, corresponding piping and/or interfaces align and mate with each other to form flow paths (e.g. LNG and vapor flow paths) between the first header module 201A and the third header module 201C.

Header modules 201 may be configured with any suitable number of vertically stacked connections and end-to-end connections to form an array or grid of header modules 201. For example, the first header module 201A may be connected vertically with the second header module 201B and end-to-end with the third header module 201C. A fourth header module 201 may also be connected end-to-end to the second header module 201B and vertically to the third header module 201C. Using an array or network of header modules 201 allows the header modules 201 to be distributed across the fuel barge 104 to provide flow paths between various components of the fuel barge 104.

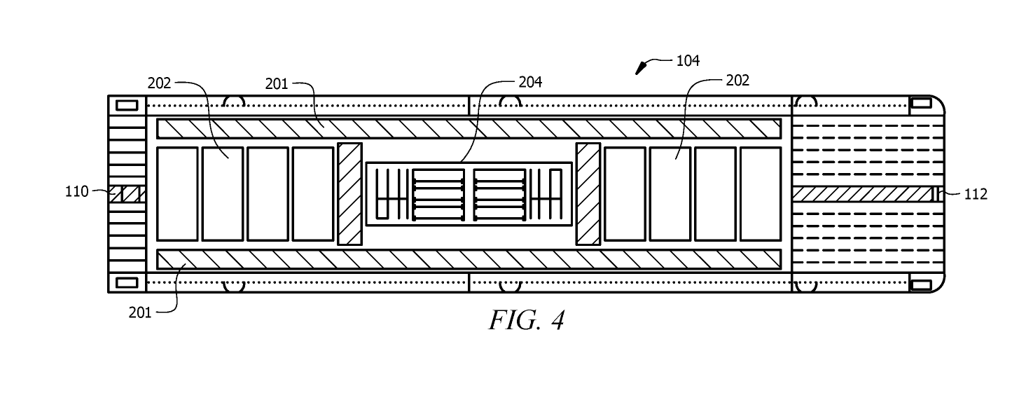

FIG. 4 is a top view of an embodiment of a fuel barge 104. The fuel barge 104 is generally configured to store a liquid (e.g. LNG), to convert the liquid to a vaporized gas, and to transfer the vaporized gas to another marine vessel. The fuel barge 104 comprises two bays of tanks 202, a network of header modules 201, and a vaporizer skid 204. The fuel barge 104 may be configured as shown or in any other suitable configuration.

The header modules 201 are configured to form a piping network across the fuel barge 104 to provide flow paths between the tanks 202, the vaporizer skid 204, the connective interfaces 110 and 112, and any other components of the fuel barge 104.

In FIG. 4, each tank 202 is integrated with a 20 foot ISO container. Each bay of tanks 202 comprises four tanks 202 positioned side by side along the longitudinal axis of the fuel barge 104. One or more of the visible tanks 202 in each bay may be stacked on top of other tanks 202. Each of the tanks 202 is operably coupled to one or more of the header modules 201, the fuel barge 104, and/or secured in place using cellular guides 203. The header modules 201 are configured to provide flow paths from the tanks 202 to other components of the fuel barge 104, for example, vaporizer skid 204 and connective interface 110 and 112.

The vaporizer skid 204 may be configured to be operably coupled with and use all of the tanks 202 or a subset of the tanks 202. The vaporizer skid 204 is configured to convert a liquid (e.g. LNG liquid) to a gas (e.g. vaporized LNG). The fuel barge 104 may comprise any suitable type of vaporizer as would be appreciated by one of ordinary skill in the art upon viewing this disclosure. The vaporizer skid 204 may be positioned in any suitable location on the fuel barge 104. For example, the vaporizer skid 204 may be positioned on the fuel barge 104 in accordance with tank 202 and header module 201 configurations, applicable regulations, and/or design standards.

The vaporizer skid 204 may be a standalone system or module configured to integrate with the fuel barge 104. For example, the vaporizer skid 204 may be integrated within an ISO flat rack, which allows the vaporizer skid 204 to be added to or removed from the fuel barge 104. In other examples, the vaporizer skid 204 may integrated with the fuel barge 104 using any other suitable structure or technique. The vaporizer skid 204 is operably coupled to one or more of the header modules 201. The header modules 201 are configured to provide flow paths from the vaporizer skid 204 to other components of the fuel barge 104, for example, connective interface 110 and 112.

The vaporizer skid 204 may be configured to control the distribution of a vaporized gas to other end-user systems. For example, the vaporizer skid 204 may be configured to transfer about half of the generated vaporized gas to a first end-user system via connective interface 110 and about half of the generated vaporized gas to a second end-user system via connective interface 112. In other examples, the vaporizer skid 204 may be configured to use any other distribution ratios for distributing vaporized gas to end-user systems. In some embodiments, the fuel barge 104 may comprise a plurality of vaporizer skid 204. Each vaporized skid 204 may be operably coupled to any suitable number of tanks 202.

In one embodiment, the vaporizer skid 204 is controlled by a controller comprising one or more processors. For example, a programmable logic controller (PLC) may be employed to control and operate the vaporizer skid 204. The controller may further comprise a memory operable to instructions for operating the vaporizer skid 204.

In some embodiments, LNG and/or other liquid commodities may be stored on the fuel barge 104 and transferred, for example, in bulk, to a marine vessel. Examples of other liquid commodities that may be stored include, but are not limited to, light distillate fuels (e.g. diesel), water, and bulk lube oils. In some embodiments, the fuel barge 104 is configured to store or carry any other type of cargo. For example, the fuel barge 104 may be configured to provide additional storage capacity for the marine vessel it is connected to. In some embodiments, the fuel barge 104 may be configured to simultaneous transfer liquid commodities (e.g. liquid LNG) and vaporized gas (e.g. vaporized LNG) to one or more external or onboard end-user systems.

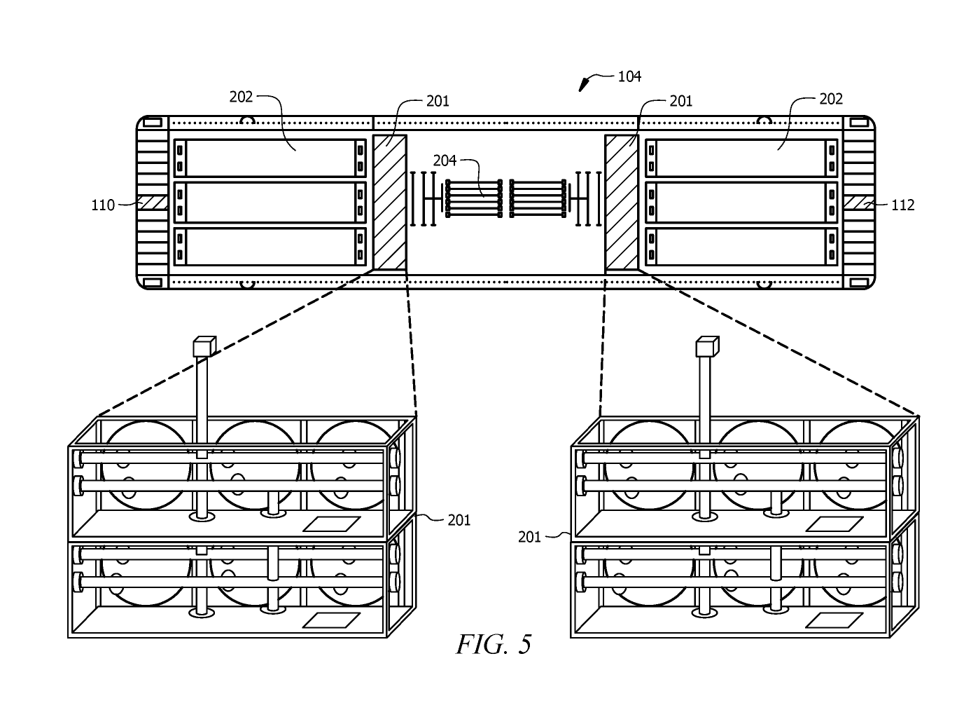

FIG. 5 is a top view of another embodiment of a fuel barge 104. The fuel barge 104 comprises two bays of tanks 202, a network of header modules 201, and a vaporizer skid 204. The fuel barge 104 may be configured as shown or in any other suitable configuration.

The header modules 201 and the vaporizer skid 204 are configured similar to the header modules 201 and the vaporizer skid 204 described in FIG. 4. In FIG. 5, each tank 202 is integrated with a 40 foot ISO container. Each bay of tanks 202 comprises three tanks 202 positioned side by side along a direction perpendicular to the longitudinal axis of the fuel barge 104. One or more of the visible tanks 202 in each bay may be stacked on top of other tanks 202. Each of the tanks 202 is operably coupled to one or more of the header modules 201, the fuel barge 104, and/or secured in place using cellular guides 203.

In some embodiments, the fuel barge 104 comprises one or more on-board end-user systems. An on-board end-user system is a self-contained, modular based, standalone system configured to integrate with the fuel barge 104. Examples of an on-board end-user system include, but are not limited to, a power generation module, a fire suppression module, a safety equipment module, a control and safety monitoring module, and a desalinization module. For example, a power generation module may be an on-board gas fired auxiliary power generation configured to provide power for cold-ironing of a marine vessel, power for an onboard desalinization module (e.g. fresh water production), power for industrial applications (e.g. dredging), and/or power for any other type of system or application. The one or more intermodal modules may be disposed in any suitable location on the fuel barge 104.

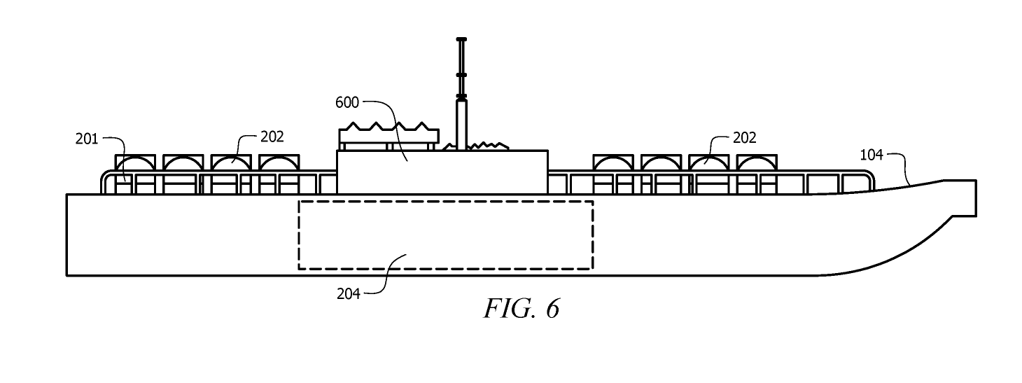

FIG. 6 is a side view of an embodiment of a fuel barge 104 with a power generation module 600. The fuel barge 104 comprises tanks 202, a network of header modules 201, and a vaporizer skid 204. The tanks 202, header modules 201, and the vaporizer skid 204 are configured similar to the tanks 202, the header modules 201, and the vaporizer skid 204 described in FIG. 4. The fuel barge 104 may be configured as shown or in any other suitable configuration.

The power generation module 600 may be a commercially available system or a custom-built system. The power generation module 600 may be an enclosed intermodal modular system comprising a generator set, fans, an air inlet, sound insulation, exhaust system, and/or any other suitable components. An example of the power generation module 600 includes, but is not limited to, a natural gas powered generator assembly.

The power generation module 600 may be a self-contained, modular based, standalone system configured to integrate with the fuel barge 104. For example, the power generation module 600 may be integrated within a modular structure (e.g. an ISO container), which allows the power generation module 600 to be added to or removed from the fuel barge 104. In other examples, the power generation module 600 may be integrated with the fuel barge 104 using any other suitable structure or technique.

The power generation module 600 is operably coupled to one or more of the tanks 202, the vaporizer skid 204, and/or one or more of the header modules 201. The header modules 201 are configured to provide flow paths between the tanks 202, vaporizer skid 204, and the power generation module 600. The power generation module 600 may be configured to obtain fuel from one or more of the tanks 202 and/or the vaporizer skid 204 and to provide power (e.g. electric power or mechanical power) for another system or device. For example, the power generation module 600 is configured to use vaporized LNG gas from the vaporizer skid 204 as a fuel source to operate the power generation module 600. For instance, the power generation module 600 may be configured to provide power for a dredge, to a vessel as cold-ironing power, or to a drop-in water desalinization module fitted onboard the fuel barge 104 or on shore.

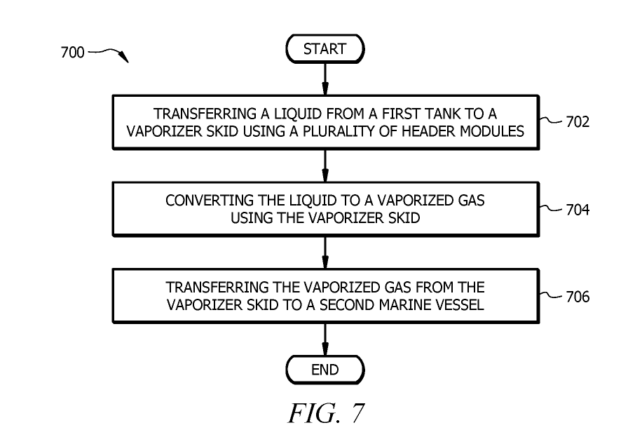

FIG. 7 is a flowchart of an embodiment of a fuel distribution method 700. Method 700 may be employed by a controller on the fuel barge 104 to provide a vaporized gas (e.g. vaporized LNG gas) to another marine vessel (e.g. a push boat or barge) as fuel source. For example, method 700 allows the fuel barge 104 to provide fuel to another marine vessel from the tanks 202 disposed on the fuel barge 104. In other words, the fuel barge 104 stores and displaces fuel that is consumed by the second marine vessel on the fuel barge 104. Method 700 also allows the natural gas vaporization to be displaced from the marine vessel by performing the natural gas vaporization on the fuel barge 104 prior to communicating the fuel to the marine vessel.

At step 702, the controller transfers a liquid from a first tank 202 to a vaporizer skid 204 using a plurality of header modules 201. For example, the liquid is LNG liquid. The liquid is communicated from the first tank to the vaporizer skid 204 using one or more header modules 201. The header modules 201 provide a flow path between the first tank 202 and the vaporizer skid 204.

At step 704, the controller converts the liquid to a vaporized gas using the vaporizer skid 204. For example, the vaporized gas is vaporized LNG gas. The vaporizer skid 204 may convert the LNG liquid to a vaporized natural gas using any suitable technique as would be appreciated by one of ordinary skill in the art.

At step 706, the controller transfers the vaporized gas from the vaporizer skid 204 to a second marine vessel. For example, the vaporizer skid 204 communicates the vaporized LNG gas to the marine vessel and/or interconnected barges via header modules 201 and connective interface hoses or hard arms (e.g. connective interface 110 or 112) that are connected to the marine vessel. The header modules 201 provide a flow path between the vaporizer skid 204 and the connective interfaces 110 and 112. The header modules 201 act as a natural gas distribution piping system for the fuel barge 104.

In one embodiment, at least a portion of the vaporized gas may be used as fuel to provide power, energy, and/or heat to the other marine vessel or to modular equipment that is onboard (e.g. an on-board desalinization module or an on-board power generation module). The header modules 201 provide a flow path between the vaporizer skid 204 and the end-user systems.

In some embodiments, the fuel barge 104 may be configured to convert other liquid commodities that are stored on the fuel barge 104 from one state (e.g. liquid) to another state (e.g. gas or vapor) and to output the vaporized liquid commodity to another marine vessel as fuel.

In some embodiments, the fuel barge 104 maybe configured to directly transfer liquid commodities to another marine vessel or end-user system. For example, the fuel barge 104 may be configured to transfer LNG liquid from one or more tanks 202 to another marine vessel. In one embodiment, the fuel barge 104 is configured to provide a flow path between the tanks 202 and the end-user system via a connective interface. The flow path between the tanks 202 and the end-user system may be used to communicate liquid from the tanks 202 to the end-user system. In one embodiment, the fuel barge 104 is configured to suspend the communication of the gas to the end-user system when the fuel barge 104 is communicating liquid to from the tanks 202 to the end-user system. In another embodiment, the fuel barge 104 is configured to simultaneously provide liquid from the tanks 202 and gas from the vaporizer skid 204 to the end-user system.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. §112(f) as it exists on the date of filing hereof unless the words “means for” or “step for” are explicitly used in the particular claim.

1. A system comprising:
a marine vessel;
a vaporizer skid disposed on the marine vessel, the vaporizer skid configured to convert a liquid to a gas;
a first tank disposed on the marine vessel, the first tank configured to store the liquid;
a plurality of header modules disposed on the marine vessel, wherein:
at least one of the plurality of header modules is operably coupled to the first tank,
the plurality of header modules form a piping network, and
the plurality of header modules provide:
a first flow path from the first tank to the vaporizer skid, and
a second flow path from the vaporizer skid to a connective interface; and
the connective interface configured to provide a flow path from at least one of the plurality of header modules to an end-user system.

2. The system of claim 1, wherein the end-user system is a second marine vessel.

3. The system of claim 1, wherein the end-user system is an onshore power generation system.

4. The system of claim 1, wherein the end-user system is an on-board power generation system.

5. The system of claim 1, wherein the end-user system is an onshore desalinization system.

6. The system of claim 1, wherein the end-user system is an on-board desalinization system.

7. The system of claim 1, further comprising a cellular guide disposed on the marine vessel, wherein:
the plurality of header modules are coupled to the marine vessel using the cellular guide; and
the cellular guide is configured to at least partially secure the first tank to the marine vessel.

8. The system of claim 1, wherein:
the plurality of header modules are configured to provide a third flow path from the first tank to the connective interface;
the third flow path is configured to communicate the liquid to the end-user system; and
the second flow path is configured to suspend the communication of the gas to the end-user system when the third flow path is in use.

9. The system of claim 1, further comprising a second connective interface configured to provide a flow path from at least one of the plurality of header modules to a second external system, and
wherein the plurality of header modules provide a third flow path from the vaporizer skid to the second connective interface.

10. The system of claim 1, wherein:
the liquid is liquefied natural gas (LNG) liquid, and
the gas is vaporized LNG gas.

11. A method comprising:
transferring a liquid from a first tank to a vaporizer skid using a plurality of header modules, wherein the tank, vaporizer skid, and the plurality of header modules are disposed on a first marine vessel;
converting the liquid to a vaporized gas using the vaporizer skid;
transferring the vaporized gas from the vaporizer skid to an end-user system using at least one of the plurality of header modules.

12. The method of claim 11, wherein the end-user system is a second marine vessel.

13. The method of claim 11, wherein the end-user system is at least one of an onshore power generation system and an on-board power generation system.

14. The method of claim 11, wherein the end-user system is at least one of an onshore desalinization system and an on-board desalinization system.

15. The method of claim 11, wherein:
the liquid is liquefied natural gas (LNG) liquid, and
the gas is vaporized LNG gas.

16. A system comprising:
a marine vessel;
a vaporizer skid disposed on the marine vessel, the vaporizer skid configured to convert a liquid to a gas;
a first tank disposed on the marine vessel, the first tank configured to store the liquid;
a second tank stacked on top of the first tank, the second tank configured to store the liquid;
a plurality of header modules disposed on the marine vessel, wherein:
one or more header modules from the plurality of header modules are operably coupled to the first tank and the second tank;
the plurality of header modules form a piping network,
at least a portion of the plurality of header modules are stacked vertically,
at least a portion of the plurality of header modules are connected end to end, and
the plurality of header modules provide:
a first flow path from the first tank to the vaporizer skid,
a second flow path from the second tank to the vaporizer skid, and
a third flow path from the vaporizer skid to a connective interface; and
the connective interface configured to provide a flow path from at least one of the plurality of header modules to an end-user system.

17. The system of claim 16, wherein the end-user system is a second marine vessel.

18. The system of claim 16, wherein the end-user system is at least one of an onshore power generation system and an on-board power generation system.

19. The system of claim 16, wherein the end-user system is at least one of an onshore desalinization system and an on-board desalinization system.

20. The system of claim 16, wherein:
the liquid is liquefied natural gas (LNG) liquid, and
the gas is vaporized LNG gas.
